(19) United States
(12) Patent Application Publication
(10) Pub. No.: US 2003/0182793 A1
(43) Pub. Date: Oct. 2, 2003

(54) Apparatus for forming flat galvanic elements

(75) Inventors: Rainer Hald, Ellwangen (DE); Markus Zeberer, Noerdlingen (DE); Thomas Haake, Dinkelsbuehl (DE); Dejan Ilic, Ellwangen (DE)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: VARTA Microbattery GmbH, a corporation of Germany, Hannover (DE)

(21) Appl. No.: 10/387,297

(22) Filed: Mar. 12, 2003

(30) Foreign Application Priority Data
Mar. 27, 2002 (DE) 102 13 685.8

(51) Int. Cl. B23P 19/00

(52) U.S. Cl. 29/730

(57) ABSTRACT

Apparatus for forming flat galvanic elements, wherein a large number of flat cells are inserted next to one another in recesses in a holder, wherein the recesses have been adapted to suit the cross-section of the cells. Conductor tabs on the flat cells point in the same direction and are clamped between contacting springs in the form of plates arranged on holders. The contacting springs contact both sides of the conductor tabs and have contacting surfaces that are much wider than the conductor tabs.

### RELATED APPLICATION

This application claims priority of German Patent Application No. DE 102 13 685.8, filed Mar. 27, 2002.

### FIELD OF THE INVENTION

The invention relates to an apparatus for forming flat galvanic elements, which are also hereinafter referred to as “flat cells”.

### BACKGROUND

In many cases, rechargeable galvanic elements, in particular, lithium-ion cells, contain a stack of cells consisting of several individual elements. The individual cells, or individual elements, from which such cell stacks are assembled are laminates created from conductors, active electrode films, and separators. Such laminates consisting of permanently interconnected individual elements are manufactured in the form of, in particular, so-called “bicells” having the possible sequences of negative electrode-separator-positive electrode-separator-negative electrode or positive electrode-separator-negative electrode-separator-positive electrode.

Methods for manufacturing such rechargeable lithium-ion cells are described in U.S. Pat. No. 5,460,904. In the case of those methods, active materials and additives, such as, if necessary, conductivity enhancers in the electrodes or stabilizers in the separators, a special copolymer, for example, polyvinylidene difluoride-hexafluoropropylene (PVDF-HFP), and parts of a plasticizer, in many cases, dibutylphthalate (DBP), are thoroughly mixed and drawn into a foil, following addition of acetone to release the copolymer. The electrode foils and separator foils fabricated in this manner are processed into the aforementioned bicells in several lamination processes. Several bicells are stacked atop one another to form a stack. This stack is inserted into a container fabricated from, for example, deep-drawn laminated aluminum foil, the container filled with electrolyte, sealed with a cap, the stack formed, sealed with an end-seal, and the resultant assembly fabricated into a finished cell.

Forming large numbers of such flat cells requires elaborate apparatus on which the conductors, or cells' electrical terminals, are electrically contacted during forming and the cells are held in place. For example, if flat cells of this type are laid flat and rest on the conductors provided on the individual cells, their contacting pins will be pressed up against them. Elaborate rebuilding and adaptations one necessary if the configuration or spacings of the conductors are altered.

It would therefore be advantageous to create an apparatus for forming a large number of flat galvanic elements, in particular, flat cells, such as lithium-ion cells, that will be suitable for uniformly subjecting a large number of elements to the forming process and that, in particular, will allow forming elements having variously configured conductor tabs without special rebuilding.

### SUMMARY OF THE INVENTION

This invention relates to apparatus for forming a multiplicity of substantially flat galvanic elements having a plurality of conductor tabs extending outwardly therefrom including an element holder having a multiplicity of recesses sized and shaped to receive the elements, and a multiplicity of conductor holders having contacts positioned to contact the conductor tabs when the elements are inserted into the recesses.

### BRIEF DESCRIPTION OF THE DRAWINGS

The apparatus according to the invention will be discussed in greater detail in the following, based on the figures, which have been confined to schematic representations:

FIG. 1 depicts a conventional manner for contacting a flat cell;

FIGS. 2, 3, and 4 depict contacting arrangements according to aspects of the invention; and

FIG. 5 depicts a forming apparatus according to aspects of the invention.

### DETAILED DESCRIPTION

It will be appreciated that the following description is intended to refer to specific embodiments of the invention selected for illustration in the drawings and is not intended to define or limit the invention, other than in the appended claims.

According to preferred aspects of the invention, a large number of flat elements are inserted next to one another into recesses on the apparatus that have been adapted to suit the crosssection of the cells, where the conductor tabs on the flat cells point in the same direction and rest on contacts that are arranged on holders and may be preferably in the form of plates. They may also be clamped between the contacts. These contacts are, in particular, situated on both sides of the conductor tabs and have contacting surfaces that are much wider than the conductors. They may be contacting springs. The galvanic elements may be lithium-ion calls of the type at the outset hereof.

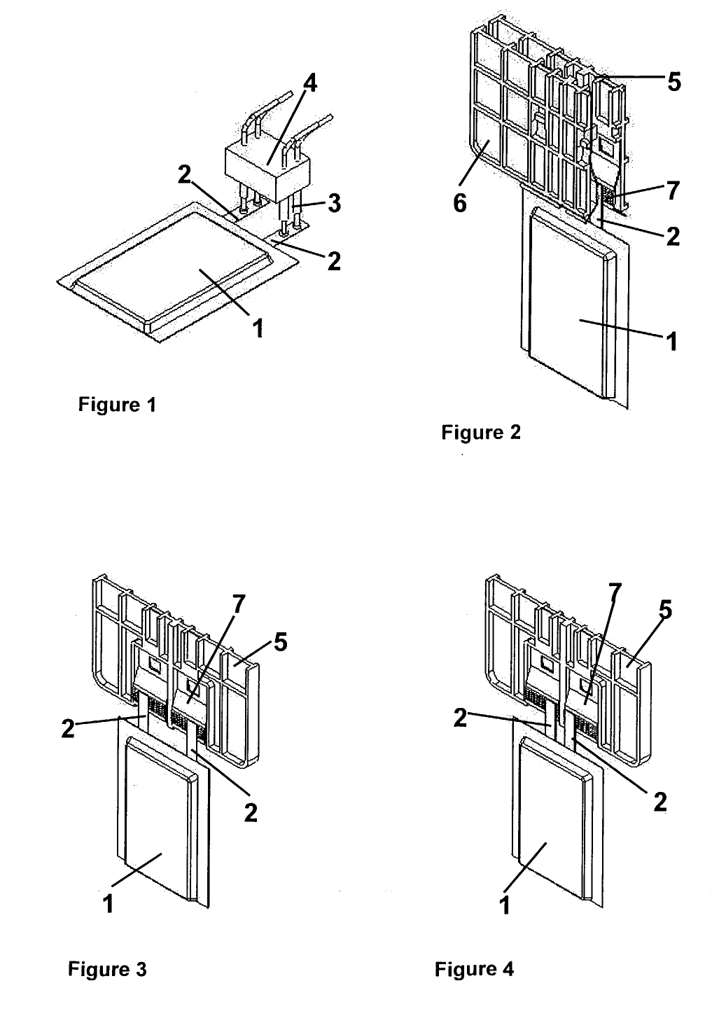

Turning to the Drawings, FIG. 1 depicts a flat cell 1 having conductor tabs 2 contacted in a conventional manner by contacting pins 3 connected to a schematically represented power supply 4.

FIG. 2 depicts the same flat cell 1 having conductors 2 arranged between conductor holders 5, 6 that are shown in their opened positions. At least one of these holders 5, 6 carries contacting springs 7. These contacting springs 7 have large contacting areas and may be pressed up against both sides of the conductor tabs 2. The large contacting areas of these contacting springs 7 allow checking a wide variety of different types of cells on the same apparatus, as may be seen from FIGS. 3 and 4. Namely, a large number of different conductor spacings may be accommodated without changing the contacting springs 7. As may be seen from the example shown in FIGS. 3 and 4, both conductor tabs 2 having very close spacings and conductor tabs 2 having very wide spacings may be contacting using the same contacting springs 7.

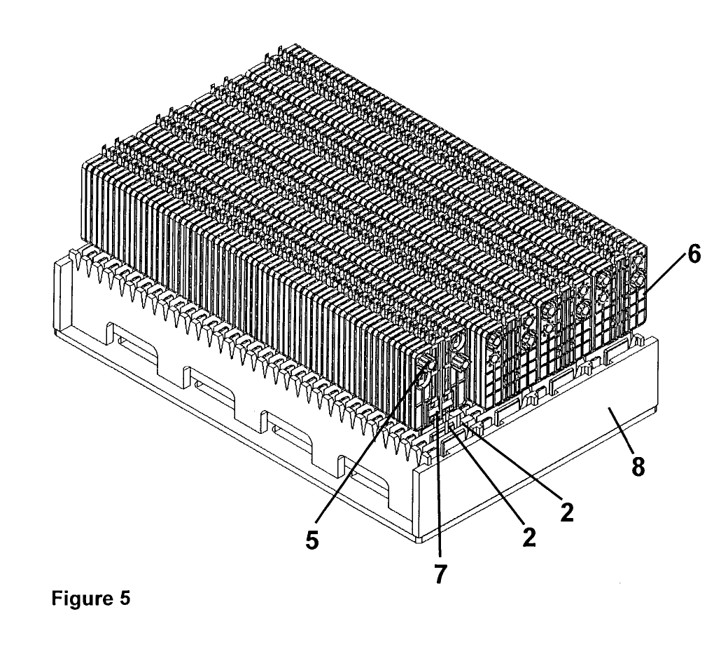

FIG. 5 depicts a forming apparatus according to aspects of the invention that is an element holder 8 for a large number of flat cells arranged next to one another. The individual flat cells are arranged in recesses in the element holder 8, which has been adapted to suit the crosssection of the cells. Their conductor tabs 2 are arranged such that all of them point in the same direction, in particular, upward. These conductor tabs 2 are clamped between the large-area contacting springs 7 during forming.

As mentioned above, the large contacting areas of contacting springs 7 according to aspects of the invention allow contacting a wide variety of flat cells having various dimensions and various spacings of their conductor tabs, which eliminates the need for capital investments in additional contacting units and the cost of warehousing such units. Moreover, no lengthy set-up times are required during manufacturing operations, and the forming apparatus flexibly adapts itself to various cell configurations. Contacting both sides of conductor tabs allows reliably contacting them, without taking up much space.

1. Apparatus for forming a multiplicity of substantially flat galvanic elements having a plurality of conductor tabs extending outwardly therefrom comprising:
an element holder having a multiplicity of recesses sized and shaped to receive said elements, and
a multiplicity of conductor holders having contacts positioned to contact said conductor tabs when said elements are inserted into said recesses.

2. The apparatus according to claim 1, wherein said contacts are contacting springs.

3. The apparatus according to claim 2, wherein each contacting spring comprises a base portion fixed to a conductor holder and a contact surface extending from the conductor holder at an angle such that an end portion of each conductor tab conductively engages said contact surface.

4. The apparatus according to claim 1, wherein said conductor tabs are clamped between contacts.

5. The apparatus according to claim 1, wherein said contacts contact both sides of said conductor tabs.

6. The apparatus according to claim 1, wherein each of said contacts comprises a pair of plates, wherein said contacts have contacting surfaces and said contacting surfaces are wider than said conductor tabs.

7. The apparatus according to claim 6, wherein each contacting spring comprises a base portion fixed to a plate and said contact surface extends from the plate at an angle such that an end portion of each conductor tab conductively engages said contact surface.
